(19) United States
(12) Patent Application Publication
(10) Pub. No.: US 2020/0360952 A1
(43) Pub. Date: Nov. 19, 2020

(54) APPARATUS, SYSTEM, AND METHOD FOR AUTOMATED LIQUID APPLICATION ON THE EXTERIOR OF INDUSTRIAL SURFACES

(71) Applicant: Terran Madsen, Fallbrook, CA (US)

(72) Inventor: Terran Madsen, Fallbrook, CA (US)

(21) Appl. No.: 16/411,349

(22) Filed: May 14, 2019

(51) Int. Cl. B05B 13/04; B05B 15/62

(52) U.S. Cl. CPC B05B 13/041; B05B 15/62

(57) ABSTRACT

An adaptable method and apparatus for applying pressurized liquids to the exterior of industrial surfaces, such as large, commercial buildings. The method and apparatus are capable of being programmed for automated use and capable of being used with fewer people, reducing the need for more expensive equipment and allowing companies to maintain and reach areas that they may not have been able to easily access before. The pressurized liquid application could be for the application of paint or high-pressure water solutions for cleaning.

### TECHNICAL FIELD

Various embodiments relate generally to applying pressurized liquids to an exterior of an industrial surface, particularly those apparatuses and methods adoptable to automatedly applying pressurized liquids to an industrial surface.

### BACKGROUND

Maintaining the exterior of industrial surfaces can be both difficult, expensive, and risky to the people performing the task. Exterior maintenance can include pressure washing or painting and priming. When someone is performing maintenance tasks such as these on tall, commercial buildings or other large industrial structures, special safety equipment needs to be used, the people performing the maintenance may be exposed to dangerous chemicals or situations, the maintenance process takes a long time, and there are high costs associated with the maintenance. Furthermore, in today's increasingly dense urban populations, buildings may not have sufficient clearance for a person and the necessary equipment to fit between structures.

Currently, a suspended platform is attached to the roof of the building, from a ceiling, or a structure is erected on the outside of the building or structure. Then, people are lowered or raised to perform tasks at close range on various sections of the structure. After completing one vertical section, they may need to adjust the platform from the top and start the process over again. Due to the high cost and how long the process takes, not to mention other prohibitive factors such as clearance or difficult to access structures, maintenance may not be done as often as would be ideal.

Accordingly, a need exists to increase efficiency, decrease safety risks, and increase accessibility to some of those more difficult areas. The present apparatus, system, and method allow for more maintenance to be performed by fewer people, thereby reducing costs. The present invention also allows people performing the maintenance operations to safely and remotely perform the tasks, reducing exposure to falling risks and exposure to potentially hazardous chemicals. The present invention, therefore, not only addresses drawbacks present in the current systems and apparatuses available, but also provides added benefits.

### SUMMARY

Apparatus and associated methods relate to an industrial liquid application system and apparatus for the exterior of industrial surfaces. In an illustrative example, an apparatus consists of one or more sprayer trolleys, suspended from cables, that automatedly, semi-automatedly, or manually moves along the exterior of industrial structure surfaces for the purpose of performing maintenance operations, such as painting or cleaning. The sprayer trolley operations can be programmed to avoid or manually started and stopped to avoid structural elements such as windows or open spaces. Associated methods are proposed to ensure that any user makes the most effective use of the system and apparatus.

Ideally, the liquid application system and apparatus evenly and consistently applies liquid to these industrial surfaces, while reducing the currently necessary manpower and equipment; reducing people's exposure to harmful chemicals over time; and allowing for maintenance of industrial exteriors that are currently often neglected due to their lack of accessibility. For example, many buildings in densely populated areas lack proper clearance to properly and cost-effectively clean and maintain the exteriors on all sides. An alternative example may be that building maintenance companies could save money currently used on expensive safety equipment or could increase efficiency amongst employees or contractors. With the use of the proposed system and apparatus, both can be achieved, since people will no longer be suspended on a platform. Those maintaining the buildings will see increased benefits through less exposure to harmful chemicals.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts a birds-eye perspective of an exemplary automated spraying system in use.

FIG. 2 depicts an exemplary interior of a sprayer trolley apparatus.

FIG. 3 depicts an alternative interior perspective of an exemplary sprayer trolley apparatus.

FIG. 4 depicts an exemplary remote controller which may be used to control a sprayer trolley apparatus.

Like reference symbols in the various drawings indicate like elements.

### DETAILED DESCRIPTION OF ILLUSTRATIVE EMBODIMENTS

An automated liquid application system is proposed comprising a sprayer trolley that can either manually or automatedly move horizontally and vertically along the exterior of a building or large industrial surface, evenly spraying liquid on the wall. Embodiments of the system may comprise one or more different system designs for implementing automation or for suspending the sprayer trolley. Each design would be optimized for specific industrial exteriors and for specific liquid application.

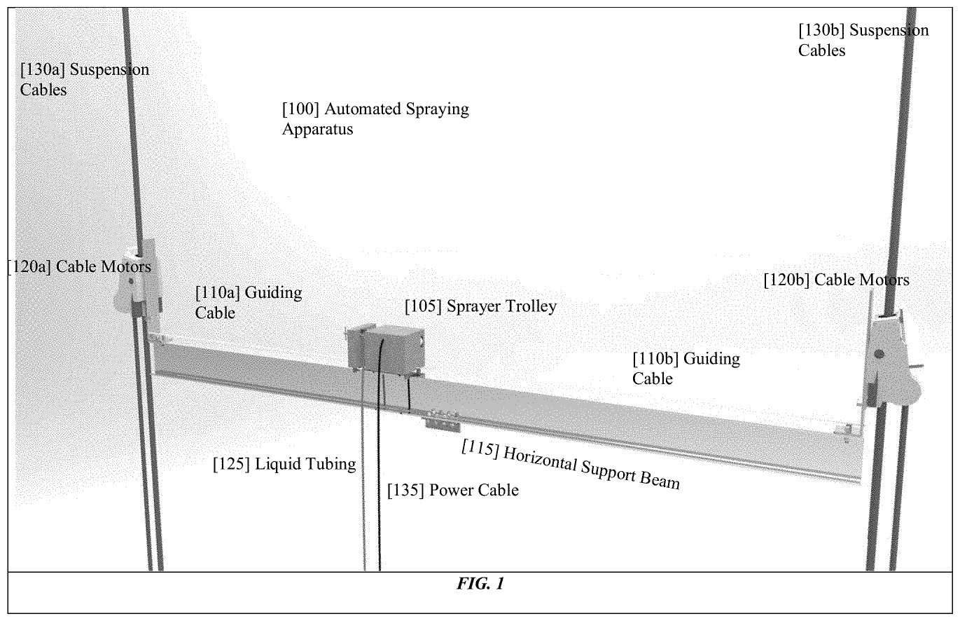

FIG. 1 depicts a birds-eye perspective of an exemplary liquid application system with the ability to be controlled manually or automatedly. The liquid application system [100] is constructed of a sprayer trolley [105] moving horizontally along guiding cables [110a-b] held in a vertical position with suspension cables [130a-b], where the vertical position is adjusted using the cable motors [120a-b]. The sprayer trolley [105] is further supported by a horizontal support beam [115]. In some embodiments, the sprayer trolley [105] may be suspended on the guiding cables only [110a-b] or may be supported on a horizontal support beam [115] only. The horizontal support beam [115], guiding cables [110a-b], and sprayer trolley [105] system is connected to cable motors [120a-b] allowing automated adjustments to the system vertically up and down the suspension cables [135]. In some embodiments, the support structure [130] may be additionally constructed or alternatively constructed of rigid beams. As the sprayer trolley [105] moves horizontally along guiding cables [110a-b], liquid tubing [125] transports liquid from an exterior, remote source to the sprayer trolley [105], and then from the sprayer trolley [105] to be applied onto an exterior surface. In some embodiments, the liquid applied may be paint or primer. In some embodiments, the liquid applied may be water, with or without additional chemicals, used for pressurized cleaning of the exterior surface. The sprayer trolley [105] is powered by a power cable [135]. In some embodiments, the power cable [135] may be connected to an electrical grid or may be connected to a generator.

In some embodiments, the sprayer trolley [105] may not be configured with a power cable and, instead, may have a rechargeable inner power source. In some embodiments, the power cable [135] may convey logical steps, executable by a computer processor, such as a program. In some embodiments, the sprayer trolley [105] may have remote connection capabilities, such as Bluetooth or wireless internet connections, to convey programming or information. In some embodiments, the sprayer trolley [105] may be additionally configured with an exterior, pressurized liquid holding tank, connected to the sprayer trolley. The motorized and automated vertical and horizontal movement capabilities of the liquid application apparatus [100] advantageously allow the apparatus to be used in various locations and for diverse purposes.

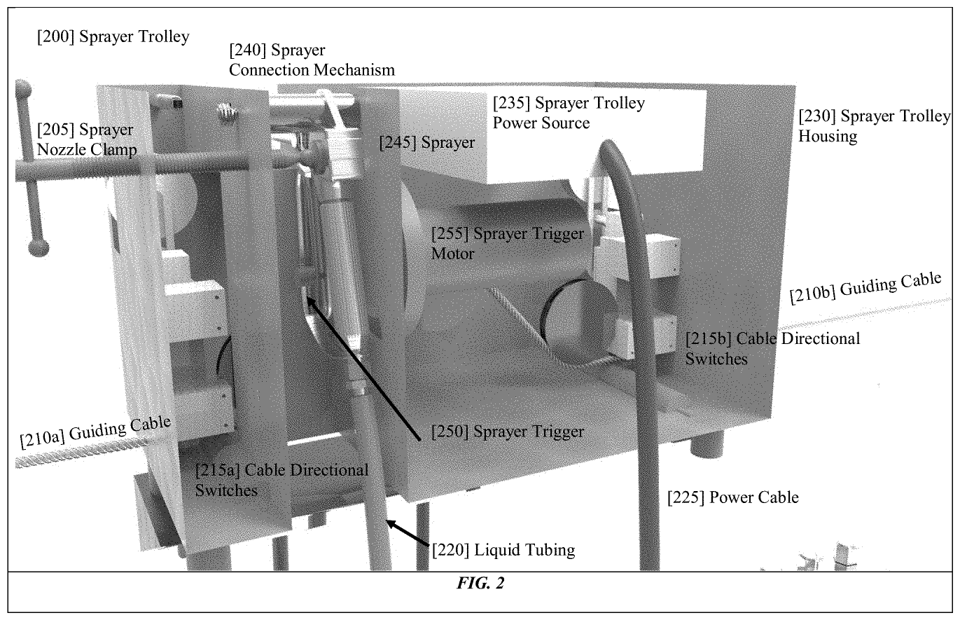

FIG. 2 depicts an exemplary sprayer trolley internal configuration. The exemplary sprayer trolley [200] is constructed of a sprayer trolley housing [230] with an access point for a sprayer nozzle clamp [205] and guiding cables [210a-b]. The exemplary sprayer trolley [200] is configured to move laterally or horizontally along a guiding cable [210a-b] and the direction can be adjusted by activating either cable directional switch [215a-b].

FIG. 2, is additionally constructed of a sprayer [245] fixed to the sprayer trolley housing [230] with the sprayer connection mechanism [240], which is then adjusted with the sprayer nozzle clamp [205]. connected to liquid tubing [220], where the liquid tubing is tubing for the purpose of transporting liquids. In some embodiments, the liquid in the liquid tubing [220] may be paint or primer for application. In some embodiments, the liquid in the liquid tubing [220] may be water, either treated with chemicals or not. In some embodiments, the liquid tubing is connected to an exterior tank or holding cell containing the paint, primer, or a water solution. The sprayer [245] is activated by engaging or disengaging the sprayer trigger [250], automatedly or manually, with the sprayer trigger motor [255]. For example, the sprayer trigger [250] may be disengaged when areas that do not need liquid application or where liquid application may be harmful, are a part of the industrial surface. These areas may be windows, large open areas, or surfaces with an irregular shape, for example. The sprayer [245] of the sprayer trolley [200] may advantageously be any standard industry sprayer which also allows for the same sprayer trolley to be used for various applications.

The apparatus of FIG. 2, the sprayer trolley [200], is further constructed with a sprayer trigger motor [255], activated by the sprayer trolley power source [235], which is connected to an external power source through a power cable [225]. In another example, the apparatus in FIG. 2 may be constructed without a sprayer trolley power source [235] or power cable [225], and may instead be constructed with a rechargeable battery. In this example, a cable may carry logical steps in the form of code to the apparatus. In some embodiments, the apparatus in FIG. 2 may be constructed with a Bluetooth or wireless connection. The sprayer trolley [200] is configured for optimal flexibility for industry professionals and, therefore, can be used with various sprayers.

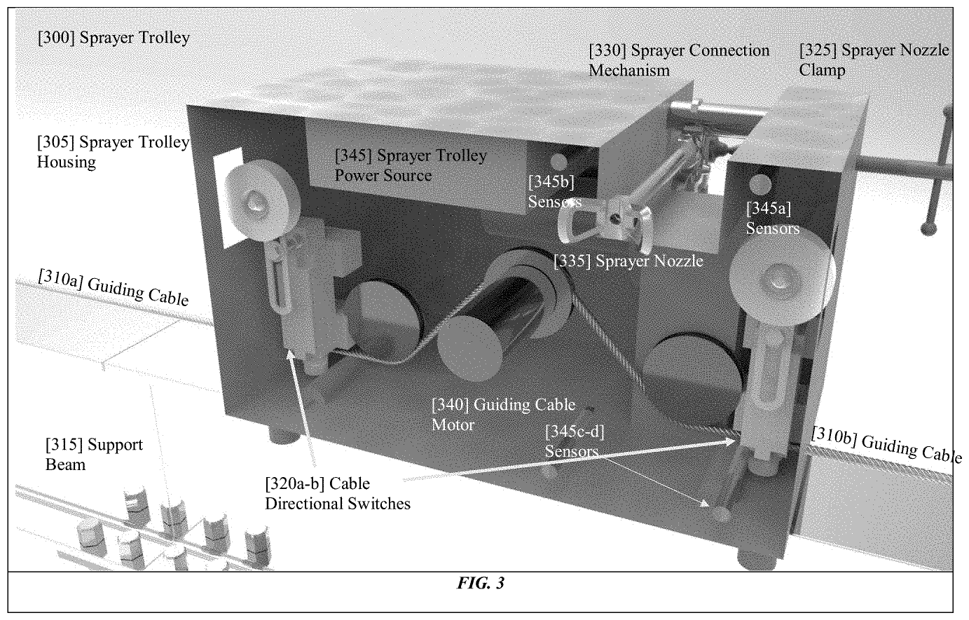

FIG. 3 depicts an alternative internal perspective of an exemplary sprayer trolley configuration moving along a support beam [315]. The sprayer trolley [300] is constructed of a sprayer trolley housing [305], a sprayer connection mechanism [330], and access ports for guiding cables [310a-b], a sprayer nozzle [335], and a sprayer nozzle clamp [325]. The sprayer trolley [300] may travel horizontally along various support structures, such as a support beam [315], using the guiding cable motor [340] to pull the sprayer trolley [300] either left or right along the guiding cable [310a-b], depending on whether the right or left cable directional switch [320a-b] is activated. The direction of the sprayer trolley [300] may be adjusted by activating one of the cable directional switches [320a-b] while deactivating the other. The sprayer trolley [300] is advantageously constructed with directional switches and motors to allow for maximum flexibility and efficiency.

The apparatus in FIG. 3, is additionally constructed with up to four sensors [345a-d]. In some embodiments, the sensors may be used to detect open spaces or windows. In some embodiments, the sensors may be used to detect changes in surface texture. In some embodiments, the sensors may be used to detect temperature changes. The sensors may all detect the same elements but they may also detect various elements. These sensors advantageously allow for the sprayer to automatedly start or stop when detecting an abnormal surface texture, for example. These embodiments have the benefit of creating a programmable sprayer trolley [300].

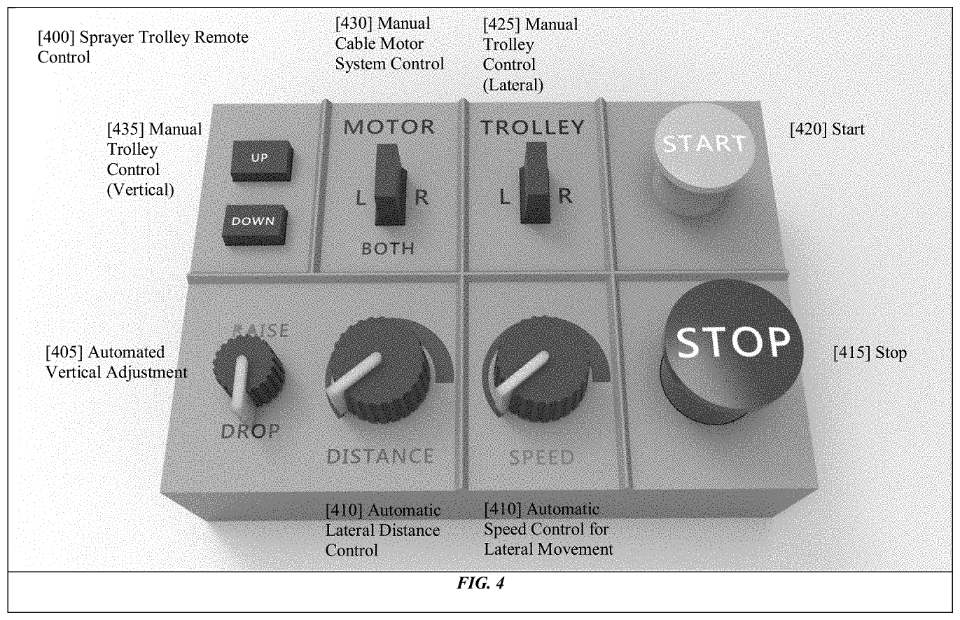

FIG. 4 depicts a view of an exemplary programmable remote control used to program or manually adjust the sprayer trolley system and apparatus from a remote location. The sprayer trolley remote control [400] is constructed predominantly of manual controls along the top row of control mechanisms and predominantly of automated controls along the bottom row of control mechanisms. The top row is configured to adjust the sprayer trolley vertically by activating or deactivating the cable motors with the manual trolley control (vertical) [435]; to activate or deactivate the cable motors with the cable motor system control [430]; to adjust the cable directional switches and guiding cable motor, and thereby control the horizontal directionality of the sprayer trolley with the manual trolley control (horizontal) [430]; and to engage the sprayer with the start [420] button. The bottom row is configured to set the sprayer trolley system to adjust vertically upwards or downwards with the automated vertical adjustment [405]; to set a distance for the sprayer trolley to travel horizontally with the automatic lateral distance control [410]; to set a speed for the sprayer trolley to travel at a set speed horizontally with the automatic speed control for lateral movement [410]; and to disengage the sprayer with the stop [415] button. This exemplary sprayer trolley remote control [400] advantageously allows for ease of use in rugged environments while providing a user with maximum flexibility to switch between manual and automated uses.

The method used by the liquid application system sets a moving speed horizontally and a horizontal distance. Once the distance is traveled, the cable motors drop the sprayer trolley a set distance to then travel horizontally at the set speed and distance, until the full industrial surface has been evenly applied with liquid.

Although various embodiments have been described with reference to the FIGs, other embodiments are possible. For example, an alternative embodiment may use an application on a computer instead of a remote control with remote connection capabilities. Those remote connection capabilities may include Bluetooth technology, wireless internet, or radio frequencies. For example, a remote may be constructed with only automated or manual controls allowed. In an alternative embodiment, an application on a mobile device or tablet may be used instead of a remote control.

An alternative embodiment may allow for a small, pressurized holding tank with the liquid to be applied attached to the sprayer trolley. An alternative embodiment may allow for various nozzles where different liquids may be applied subsequently. An alternative embodiment may allow for one nozzle applying liquid and a subsequent nozzle applying air to aid in drying a surface, housed in one sprayer trolley. An alternative embodiment may allow for more than one horizontal cable to be suspended at various vertical heights, each with a sprayer trolley, applying liquids horizontally simultaneously. An alternative embodiment may allow for more than one sprayer trolley applying liquid simultaneously along a single guiding cable and/or support beam.

For example, a liquid application system may be constructed with a trolley suspended vertically on a cable and then moving horizontally with cable motors moving the liquid application system first vertically, and then horizontally. In this embodiment, the method would reflect that change for first vertical movement and then horizontal movement.

For example, a liquid application system may be constructed for use with a building exterior. In an alternative embodiment, a liquid application system may be constructed for use with an airplane exterior. The liquid application system is best suited for large, industrial, exterior surfaces. The liquid in the liquid application system, in another example, may be an aqueous solution or may be pure water. In another example, the liquid in the liquid application system may be paint or primer.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A programmable sprayer trolley system used to maintain the exterior of industrial structures comprising:
A suspension system comprising:
two or more suspension cables fixed at a first end to an upper point with a second end to a lower point;
where the two or more suspension cables are fixed in parallel to said upper point;
one or more guiding cables operably connected at a left point perpendicularly to one suspension cable and at a right point perpendicularly to a second suspension cable where the left point and right point are connected at the same distance from the upper point; and
two or more suspension cable motors configured for simultaneous movement of the left point and right point of the guiding cables vertically. one or more sprayer trolleys, a sprayer trolley comprising:
a sprayer trolley housing defining an interior volume;
a power source configured to power one or more motors;
a sprayer nozzle fixed to the sprayer trolley housing configured to spray liquids from an exterior liquid source to the exterior of an industrial structure;
where the nozzle extrudes from the sprayer trolley housing towards an exterior of an industrial structure through an access port in the sprayer trolley housing;
where the sprayer nozzle is additionally configured with a sprayer nozzle trigger;
a sprayer nozzle trigger motor configured to engage or disengage the sprayer nozzle trigger;
an access port configured for entry and exit of a guiding cable, where the guiding cable enables movement left and right of the sprayer trolley by enabling a guiding cable directional switch and a guiding cable motor;
at least two guiding cable directional switches, a left guiding cable directional switch and a right guiding cable directional switch;
a guiding cable motor configured to enable movement of the sprayer trolley left and right along a guiding cable; and
one or more sensors configured to sense a change of materials of an exterior of an industrial structure; and
A programmable control apparatus configured to remotely control the sprayer trolley.

2. The system of claim 1, the suspension system further comprising a rigid beam fixed to the guiding cables operably connected at a second left point perpendicularly to one suspension cable and at a second right point perpendicularly to a second suspension cable where the second left point and second right point are parallel.

3. The system of claim 1, where the power source is a rechargeable battery.

4. The system of claim 1, where the power source is wired to an external power source.

5. The system of claim 1, where the sprayer nozzle is fixed to the sprayer trolley housing with a fastener and an adjustable clamp.

6. The system of claim 1, the programmable control apparatus further configured to be operated from a remote location.

7. The system of claim 5, the sprayer nozzle additionally comprising a removable tube fastened to the exterior liquid source and to the sprayer nozzle.

8. The system of claim 6, where the programmable control apparatus is a device with a processor configured to execute logical steps.

9. The system of claim 6, the programmable control apparatus further comprising manual control switches and automated control switches.

10. The system of claim 7, where the liquid is water.

11. The apparatus of claim 7, where the liquid is paint.

12. A programmable sprayer trolley used to maintain the exterior of industrial structures comprising:
a sprayer trolley housing defining an interior volume, the sprayer trolley housing comprising:
a power source configured to power one or more motors;
a sprayer nozzle fixed to the sprayer trolley housing configured to spray liquids from an exterior liquid source to an exterior of an industrial structure;
where the nozzle extrudes from the sprayer trolley housing towards an exterior of an industrial structure;
where the sprayer nozzle is additionally configured with a sprayer nozzle trigger;
a sprayer nozzle trigger motor configured to engage or disengage the sprayer nozzle trigger;
an access port configured for entry and exit of a guiding cable, where the guiding cable enables movement left and right of the sprayer trolley by enabling a guiding cable directional switch and a guiding cable motor;
at least two guiding cable directional switches, a left guiding cable directional switch and a right guiding cable directional switch;
a guiding cable motor configured to enable movement of the sprayer trolley left and right along a guiding cable;
one or more sensors configured to sense a change of materials of an exterior of an industrial structure; and
where the sprayer trolley is configured for remote control by a programmable apparatus.

13. The apparatus of claim 12, where the sprayer nozzle is fixed to the sprayer trolley housing with a fixed fastener and an adjustable clamp.

14. The apparatus of claim 13, where the power source is a rechargeable battery.

15. The apparatus of claim 13, where the power source is wired to an external power source.

16. The apparatus of claim 13, where the liquid is water.

17. The apparatus of claim 13, where the liquid is paint.

18. The apparatus of claim 17, where the industrial structure is a building.
